(19) United States
(12) Patent Application Publication
(10) Pub. No.: US 2008/0055286 A1
(43) Pub. Date: Mar. 6, 2008

(54) Method And Apparatus For Displaying Bitmap Images

(76) Inventors: Mayank Garg, Bangalore (IN); Naveen Kumar Echangur Narayana Reddy, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/554,037

(22) Filed: Oct. 30, 2006

(30) Foreign Application Priority Data
Sep. 6, 2006 (IN) 1609/CHE/2006

(51) Int. Cl. G09G 5/00

(52) U.S. Cl. 345/204

(57) ABSTRACT

A method and apparatus for displaying a bitmap image that may be only partially visible once displayed. The method comprises dividing the bitmap image into a plurality of tiles; writing the tiles to a temporary data storage; determining which of the tiles are required to display the portion of the bitmap image that will be visible when the bitmap image has been displayed; reading the required tiles from the temporary data storage; and displaying the bitmap image using the required tiles. The temporary data storage may comprise a temporary hard-disk file.

### FIELD OF THE INVENTION

The present invention relates to a method and apparatus for displaying bitmap images, of particular but by no means exclusive application in displaying bitmap images—including varying the display of such bitmap images—in .NET applications.

### BACKGROUND OF THE INVENTION

Bitmap images can be drawn on the display of a computing device in, for example, .NET applications using the “Bitmap” class defined in the “Systerm.Drawing” namespace. For very large bitmap images, when displaying the image or performing certain user interface operations (such as zooming, scrolling and panning), this class does not provide good performance; this is so with respect both to the speed of user interface operations and to memory utilisation during the display and user interface operations.

For example, one background art system employs a decompression unit configured to partially decompress a compressed image formed of compressed tiles, in which each compressed tile corresponds to a tile of the uncompressed image. The decompression unit selects a subset of relevant tiles, which are visible in a view window or a view frustum, and includes a tile selector to select the relevant tile and a tile decompressor to decompress the relevant tiles so that—by decompressing only a subset of the compressed tiles—the decompression unit reduces the processing time required to generate the contents of the view window. However, this system relies on continual compression and decompression and hence incurs significant processing overhead.

A background art graphics data rasterization method uses a cache of size equal to a selected tile size, and performs rasterization by subdividing the graphics image into a plurality of sub-blocks that are processed, based on a block processing order, by further subdivision into tiles for those sub-blocks that have graphics image data. Data, associated with a tile, is loaded into the cache, and the cache data is utilized to generate pixels for the associated tile of the graphics image. Hence, two stage subdivision is required, as is the identification of the sub-blocks that have graphics image data, both adding to the required processing overhead.

In another background art approach, Photoshop brand software employs a type of image tile caching mechanism to reduce memory usage. Since Photoshop is a GDI (Graphical Device Interface) based application, however, this approach is not suitable for .NET applications.

### SUMMARY OF THE INVENTION

The present invention provides a method and apparatus for displaying bitmap images. In one embodiment there is provided a method for displaying a bitmap image that may be only partially visible once displayed. The method comprises dividing the bitmap image into a plurality of tiles; writing the tiles to a temporary data storage; determining which of the tiles are required to display the portion of the bitmap image that will be visible when the bitmap image has been displayed; reading the required tiles from the temporary data storage; and displaying the bitmap image using the required tiles.

### BRIEF DESCRIPTION OF THE DRAWING

In order that the invention may be more clearly ascertained, embodiments will now be described, by way of example, with reference to the accompanying drawing, in which:

FIG. 1 is a schematic diagram of an apparatus for displaying bitmap images according to an embodiment of the present invention.

FIG. 2 is a flow diagram of a bitmap image displaying method according to an embodiment of the invention.

FIG. 3 is a schematic diagram of an exemplary bitmap image processed according to the method of FIG. 2.

FIG. 4 is a schematic diagram of the exemplary bitmap image of FIG. 3, further processed according to the method of FIG. 2.

FIG. 5 is a schematic diagram of the exemplary bitmap image of FIG. 3, still further processed according to the method of FIG. 2.

FIG. 6 is a flow diagram of a bitmap image zooming method according to an embodiment of the invention.

FIG. 7 is a schematic diagram of the exemplary bitmap image of FIG. 3, as displayed according to the method of FIG. 2, and illustrating the effect of zooming on the identity of the tiles required for displaying the image.

FIG. 8 is a schematic view of a data storage medium according to another embodiment of the invention.

### DETAILED DESCRIPTION

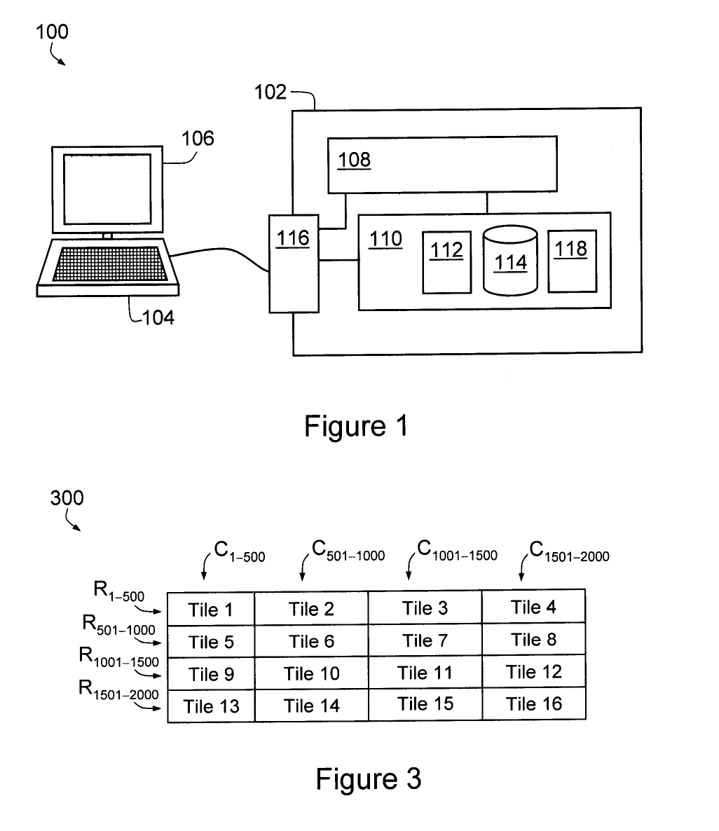

FIG. 1 is a schematic diagram of an apparatus 100 for displaying bitmap images according to an embodiment of the present invention. Apparatus 100 includes a processing unit 102, and a keyboard 104 and a display 106 in electronic communication with the processing unit 102. FIG. 1 shows only those functional components of processing unit 102 of greatest relevance to the present embodiment; thus, processing unit 102 includes a processor 108, memory 110 (which includes RAM 112 and a hard-disk drive 114) and I/O device 116 for communicating with keyboard 104 and display 106. Memory 110 also includes software 118 for execution by processor 108. Processor 108 executes software 118 and in response controls processing unit 102 to perform the functions described below.

Software 118 is adapted, when executed by processor 108, to control the display of bitmap images on display 106, and for performing user interface operations such as scrolling and panning such images.

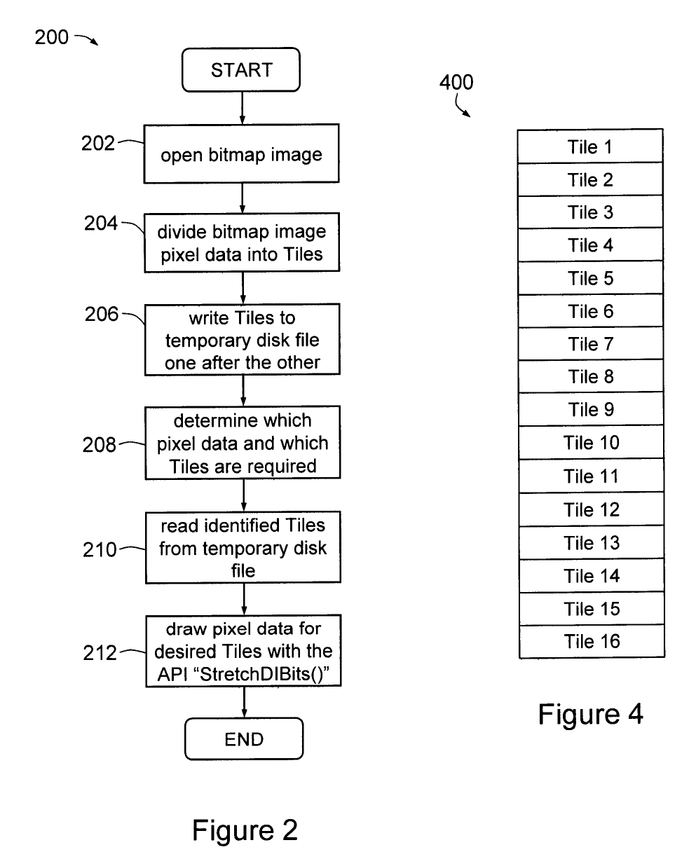

Thus, FIG. 2 is a flow diagram 200 of the steps performed by apparatus 100 under the control of software 118 for drawing a bitmap image on display 106, according to this embodiment.

At step 202, the bitmap image file—typically stored on hard-disk drive 114—is opened. As soon as this has been done, at steps 204 and 206 the entire pixel data is written to a temporary disk file on hard-disk drive 114 in a “Tiled” fashion (as is explained below). A disk file is used in this embodiment in order to obtain the maximum performance improvement with large bitmap images. Such images may have sizes ˜1 MB to 100 MB (or more), so no other form of memory will generally be appropriate for storing these quantities of data. However, this approach may optionally be modified somewhat by caching some of the frequently used Tiles (which are described below) in main memory (i.e. RAM), which would increase scrolling speed (for example) though at the expense of main memory usage.

Thus, at step 204, the whole bitmap image pixel data is divided into a plurality of Tiles of uniform size (i.e. height and width). In this embodiment, each Tile is 500×500 pixels though other Tile sizes may be employed and, optionally, the Tile size may be configurable. The Tiles of this embodiment are thus similar to those in a “Tiled” TIFF image. FIG. 3 is a schematic representation of an exemplary image 300 of 2000×2000 pixels, with rows R and columns C labelled once processed according to this step; at step 204, therefore, image 300 will be divided into 16 Tiles each of 500×500 pixels. Tile 1, for example, comprises columns 1 to 500 (C₁₋₅₀₀) from row 1 to row 500 (R₁₋₅₀₀).

At step 206, the Tiles are written to a temporary disk file one after the other, such that the pixel data for one complete Tile appears before the data of the next Tile and so on, allowing fast access to the pixel data for each Tile at the time of a subsequent read operation for such Tiles. FIG. 4 is a schematic representation of the data 400 corresponding to exemplary image 300 of FIG. 3, arranged in the temporary disk file following step 206 and indicating the individual Tiles.

At step 208, the event handler for the “Paint” event (which is fired when the image is about to be displayed in a “Form”), determines which pixel data and hence which Tiles are required (though it will be appreciated that, in some cases, the entire—or virtually the entire—image will be visible so all the Tiles will be required). The “Form” is essentially the window in which the image is to be displayed on display 106 in any standard image processing/viewing application. The location and the number of required Tiles to be loaded depend on the following four factors:

1) the height of the “Form” in which the bitmap image is to be displayed;

2) the width of the “Form” in which the bitmap image is to be displayed;

3) the horizontal scroll position of the “Form” in which the bitmap image is to be displayed; and

4) the vertical scroll position of the “Form” in which the bitmap image is to be displayed.

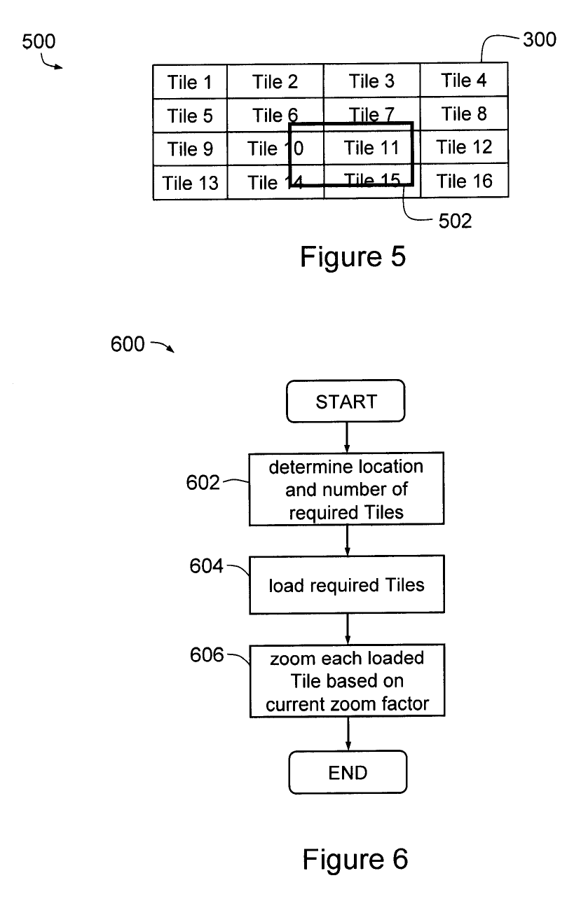

FIG. 5 is a schematic depiction 500 of the effect of this operation when applied to exemplary image 300 of 2000×2000 pixels, and assuming a “Form” size of less than the image size so that the scroll bars appear in the “Form”. FIG. 5 shows image 300 and indicates the portion 502 of image 300 that is currently visible in the “Form”. As is apparent from FIG. 5, owing to the values of the four factors listed above only six Tiles need be loaded and drawn in order to display portion 502, that is, Tile 6, Tile 7, Tile 10, Tile 11, Tile 14 and Tile 15. Hence, in this example, at step 208 the event handler identifies these six Tiles.

At step 210, the identified Tiles are read from the temporary disk file. At step 212, in the event handler for the “Paint” event, the pixel data for the desired “Tiles” of the bitmap image are drawn using, in this embodiment, the API “StretchDIBits( )”. This API is the standard WIN 32 API which is imported to C# using the “DllImport” attribute of the “System.Runtime.InteropServices” name space from the “gdi32” DLL. The pixel data for each “Tile” is drawn using the “StretchDIBits( )” API as soon as it is read from the temporary disk file.

The “WM_ERASEBKGND” event is ignored in the overridden “WndProc( )” method, so that the background is not drawn blank before every write operation. Thus, in user interface operations such as scrolling, there is less “flicker”.

It should also be noted that, according to this embodiment, frequently used Tiles may optionally also be saved in a memory cache. This should further increase speed in some applications.

Apparatus 100 can also be used to redisplay the bitmap image, such as in the course of user interface operations such as scrolling, zooming or panning the image. To do so, apparatus 100 determines which of the Tiles are required to display the portion of the image that will be visible when the bitmap image has been redisplayed, reads each of the required Tiles from the temporary data storage (or from a memory cache), and redisplaying the bitmap image using the required Tiles.

FIG. 6, for example, is a flow diagram 600 of a bitmap image zooming operation according to this embodiment; the steps of flow diagram 600 are performed by apparatus 100 under the control of software 118. The steps of flow diagram 600 would be performed after the drawing of the image according to flow diagram 200 of FIG. 2. It should be appreciated that, according to this embodiment, the image data is written to the temporary disk file once for any particular instance of opening, displaying and varying the display of such an image; hence, the following steps do not include writing the data to the temporary disk file as they are performed after the image has been displayed and hence after steps 202 to 212.

Thus, referring to FIG. 6, at step 602 the location and the number of the Tiles required to be loaded is determined, which depends on the aforementioned four factors plus the following additional factor:

5) the zoom factor (which may be greater or less than 1) to be applied to the image.

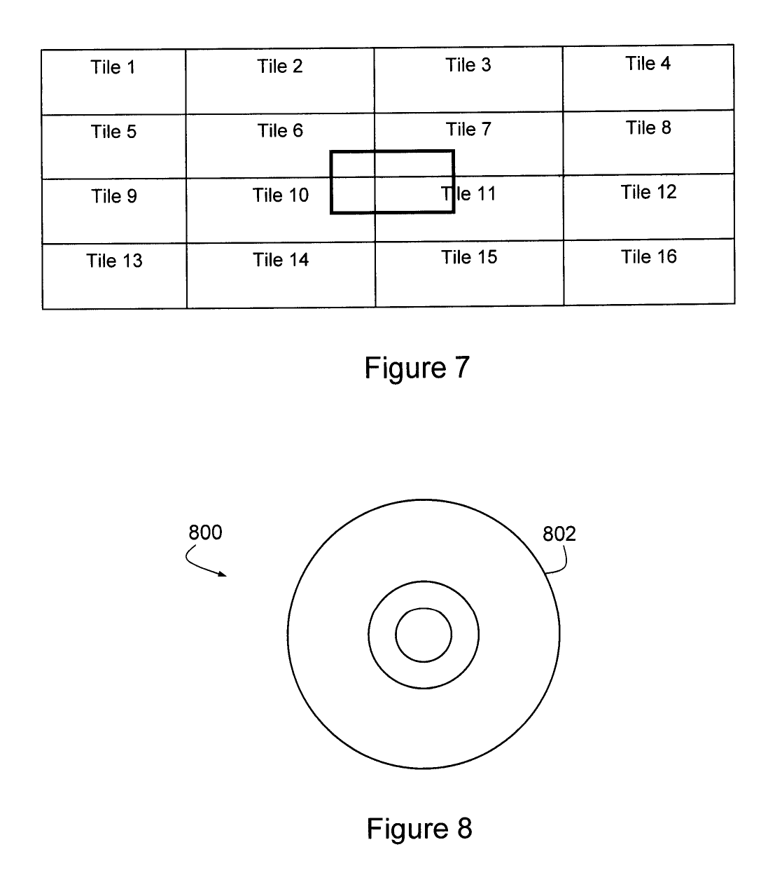

Using the same example depicted in FIGS. 3 to 5, and assuming the image is to be zoomed by a factor of 2, but keeping the position and size of the “Form” unchanged, the final (zoomed) image may be represented as shown schematically in FIG. 7. Thus, at step 602 according to this example it is determined that four Tiles are required, that is, Tile 6, Tile 7, Tile 10 and Tile 11.

At step 604, each of these Tiles is loaded from the temporary disk file on hard-disk drive 114 (or, if any have been stored in a memory cache owing to frequent use or previous display, from that cache). At step 606, each of these loaded Tiles is zoomed based on the current zoom factor applicable for the image, in this example 2. This is done by varying the destination rectangle co-ordinates specified in the “StretchDIBits( )” function according to the selected zoom factor.

Thus, in each user interface operation, it is not necessary to load the entire bitmap image into the memory, owing to the use of a temporary disk file. Loading only a few Tiles at a time of the bitmap image will lead in some cases to a greatly reduced memory usage.

The use of the “StretchDIBits( )” API and drawing only the required Tiles for every scroll operation taking into account the current zoom factor, in the “Paint” event handler, the bitmap image is drawn to the screen quickly and scrolling speed is increased. As the Tile size and the number of Tiles to be drawn are independent of the image size, even for large images the scrolling speed can be very fast.

As mentioned above, the approach of loading a Tile on a “just in time” basis may be modified by caching some Tiles in memory. This approach may in some applications further improve scrolling speed, but will increase memory usage.

For larger images, even though the drawing operation of the Tiles is clearly visible, this behaviour is similar to the Adobe PhotoShop™ application, which is considered a benchmark for imaging applications.

Also, as the “WM_ERASEBKGND” event is ignored in the “WndProc( )” method, the background is not drawn blank before every write operation so there is less flickering while scrolling.

The approach of this embodiment therefore has a number of advantages over comparable .NET applications developed using the “Bitmap” class provided by the .NET framework: it is generally more memory efficient, it provides faster user interface operations on the displayed image, and it generally provides flicker-free drawing as well as other user interface operations on the displayed image. Consequently, it is expected that, in at least some applications, it will provide performance improvements for various user interface operations (such as zooming and scrolling), or at least a useful alternative to existing approaches.

As mentioned, this method is adapted for—and is regarded as particularly useful for—.NET applications, but the same principles may be applied in essentially any other platform, without departing from the present invention. Thus, one embodiment of the invention is adapted for use with GDI based applications, another on Linux (trade mark) based systems such as the Qt (trade mark) GUI software toolkit and the KDE™ graphical environment.

Referring to FIG. 8, in another embodiment the necessary software for implementing the method of FIGS. 2 and 6 is provided on a data storage medium 800. The data storage medium 800 is in the form of a CD-ROM 802 that contains program instructions for implementing the method of FIGS. 2 and 6. It will be understood that, in this embodiment, the particular type of data storage medium may be selected according to need or other requirements. For example, instead of CD-ROM 802 the data storage medium 800 could be in the form of a magnetic medium, but essentially any data storage medium will suffice.

The foregoing description of the exemplary embodiments is provided to enable any person skilled in the art to make or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

1. A method for displaying a bitmap image that may be only partially visible once displayed, comprising:
dividing said bitmap image into a plurality of tiles;
writing said tiles to a temporary data storage;
determining which of said tiles are required to display the portion of the bitmap image that will be visible when said bitmap image has been displayed;
reading the required tiles from said temporary data storage; and
displaying said bitmap image using said required tiles.

2. A method as claimed in claim 1, including dividing said bitmap image into a plurality of tiles of uniform size.

3. A method as claimed in claim 1, including writing said tiles to said temporary data storage comprising a temporary hard-disk file.

3. A method as claimed in claim 1, including writing said tiles to said temporary data storage in a sequential order such that the pixel data for any one complete tile appears before the data pixel data of any next tile.

4. A method as claimed in claim 1, further comprising saving frequently used tiles in a memory cache.

5. A method as claimed in claim 1, further comprising determining which of said tiles are required to display the portion of the bitmap image that will be visible when said bitmap image has been redisplayed, reading each of the required tiles from either said temporary data storage or from a memory cache, and redisplaying said bitmap image using said required tiles.

6. A method as claimed in claim 6, including performing one or more user interface operations selected from the group comprising: zooming, scrolling and panning.

7. A method as claimed in claim 1, further comprising zooming the bitmap image by determining which of said tiles are required to display the portion of the bitmap image that will be visible after said bitmap image has been zoomed, loading each of the required tiles from either said temporary data storage or from a memory cache, zooming said required tiles, and redisplaying said bitmap image using said required tiles.

8. An apparatus for displaying a bitmap image that may be only partially visible once displayed, comprising:
a processor;
a temporary data storage;
a display; and
program data executable by said processor to control said apparatus to display said bitmap image by:
dividing said bitmap image into a plurality of tiles;
writing said tiles to the temporary data storage;
determining which of said tiles are required to display the portion of the bitmap image that will be visible when said bitmap image has been displayed;
reading the required tiles from said temporary data storage; and
displaying said bitmap image using said required tiles.

9. A computer readable medium provided with program data that, when executed on a computing system, implements the method of claim 1.
